(19) United States
(12) Patent Application Publication
(10) Pub. No.: US 2014/0021386 A1
(43) Pub. Date: Jan. 23, 2014

(54) SOLENOID VALVE

(71) Applicant: DENSO CORPORATION, Kariya-city (JP)

(72) Inventors: Masahiko OCHIAI, Nisshin-city (JP); Jiro KONDO, Kariya-city (JP)

(73) Assignee: DENSO CORPORATION, Kariya-city (JP)

(21) Appl. No.: 13/866,211

(22) Filed: Apr. 19, 2013

(30) Foreign Application Priority Data
Jul. 18, 2012 (JP) 2012-159512

(51) Int. Cl. F16K 31/06

(52) U.S. Cl. CPC F16K 31/0613
USPC 251/129.15

(57) ABSTRACT

A valve includes a valve housing and a linier solenoid. The linier solenoid includes a cylindrical yoke and is coupled with the valve. An open end of the yoke is crimped to a flanged crimping receiving part provided along an outer periphery of the valve housing, so that the linier solenoid and the valve are coupled together. The open end of the yoke includes a plurality of notches provided in a circumferential direction of the yoke, and the plurality of notches defines a plurality of crimping pieces. Each of the plurality of crimping pieces includes a large part and a small part. The large part is located on a base side of the each of the plurality of crimping pieces and has a larger circumferential width. The small part is located on an tip side of the each of the plurality of crimping pieces and has a smaller circumferential width.

### CROSS REFERENCE TO RELATED APPLICATION

This application is based on Japanese Patent Application No. 2012-159512 filed on Jul. 18, 2012, the disclosure of which is incorporated herein by reference.

### TECHNICAL FIELD

The present disclosure relates to a solenoid valve constructed by a valve and a linier solenoid coupled with each other by crimping.

### BACK GROUND

Conventional technologies will be described below.

Conventionally, there is provided a known solenoid valve constructed by a valve and a linier solenoid coupled with each other by crimping (see, for example, Japanese Patent No. 417249).

The valve has a valve housing, and the linier solenoid has a yoke having a cylindrical shape. The valve housing has an annular crimping part (an annular projecting part) along its outer circumference. By crimping an open end of the yoke, the open end of the yoke retains the annular crimping part to join the valve and the linier solenoid together.

The technology in Japanese Patent No. 417249 employs an entire circumference crimping structure whereby the yoke has an annular crimping part whose thickness is reduced by rolling or the like, so that the open end of the yoke easily deforms plastically by crimping load. The entire circumference of the open end of the yoke is crimped.

By employing the entire circumference crimping structure, when the annular crimping part is increased in thickness, the yoke may be broken or cracked because a crimping load is increased.

Furthermore, when the crimping load is increased, machinery cost is increased.

When the annular crimping part is increased in thickness, plastic deformation of the annular crimping part may become insufficient, in other words, plastic deformation may become under predetermined level.

When plastic deformation of the annular crimping part is insufficient, tight attachment of the valve housing to the yoke is decreased, and the valve housing rotates relative to the yoke.

### SUMMARY

The present disclosure addresses at least one of the above issues.

According to the present disclosure, there is provided a valve includes a valve housing and a linier solenoid. The linier solenoid includes a cylindrical yoke and is coupled with the valve. An open end of the yoke is crimped to a flanged crimping receiving part provided along an outer periphery of the valve housing, so that the linier solenoid and the valve are coupled together. The open end of the yoke includes a plurality of notches provided in a circumferential direction of the yoke, and the plurality of notches defines a plurality of crimping pieces. Each of the plurality of crimping pieces includes a large part and a small part. The large part is located on a base side of the each of the plurality of crimping pieces and has a larger circumferential width. The small part is located on an tip side of the each of the plurality of crimping pieces and has a smaller circumferential width.

### BRIEF DESCRIPTION OF THE DRAWINGS

The above and other objects, features and advantages of the present disclosure will become more apparent from the following detailed description made with reference to the accompanying drawings. In the drawings:

FIG. 1A is an external view illustrating a solenoid valve according to an embodiment;

FIG. 1B is an enlarged view illustrating a yoke according to the embodiment;

FIG. 2 is an enlarged view partly illustrating and example shape of crimping pieces of the yoke according to a first modification; and

FIG. 3 is an enlarged view partly illustrating an example shape of crimping pieces of the yoke according to a second modification.

### DETAILED DESCRIPTION

The present disclosure will be described hereafter referring to drawings. A part that corresponds to a matter described in a preceding embodiment may be assigned with the same reference numeral, and redundant explanation for the part may be omitted.

An embodiment will be described in detail below with reference to the accompanying drawings.

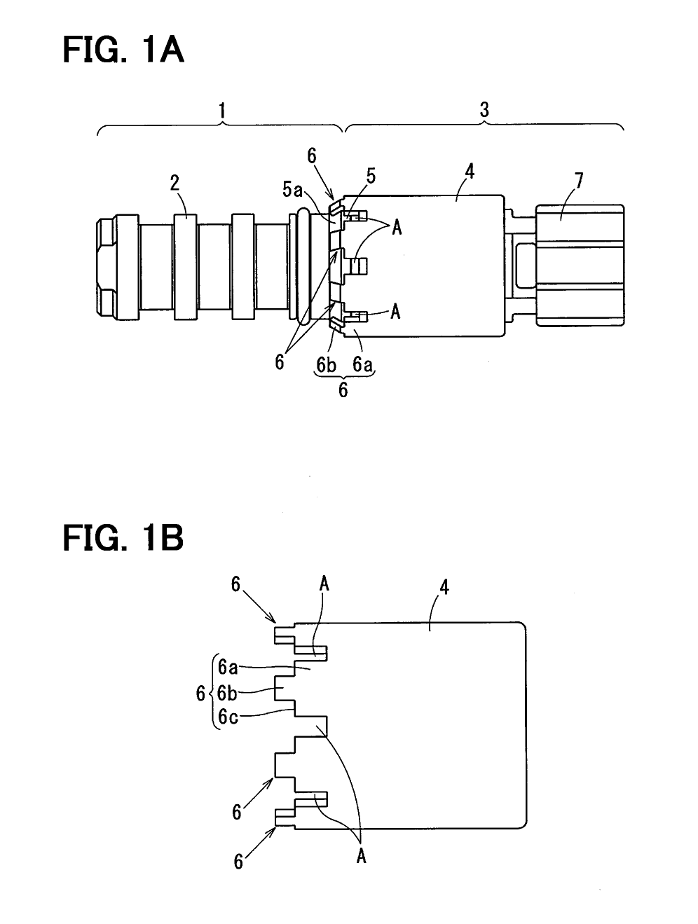

As shown in FIGS. 1A and 1B, a solenoid valve is a magnetic spool valve in which a spool valve 1 (having a cylinder sleeve 2) and a linier solenoid 3 (having a yoke 4) are coupled with each other by crimping the yoke 4 to retain the cylinder sleeve 2. The spool valve 1 is an example of a valve, and the cylinder sleeve 2 is an example of a valve housing. The cylinder sleeve 2 has a crimping receiving part 5 along its outer circumference, and the spool valve 1 and the linier solenoid 3 are coupled with each other in a manner that an open end of the yoke 4 is crimped and retains the crimping receiving part 5.

As shown in FIG. 1B, the open end of the yoke 4 crimped to retain the cylinder sleeve 2 has crimping pieces 6 and notches A that are located in a circumferential direction of the yoke 4.

Each of the crimping pieces 6 has a large part 6a having a larger circumferential width and a small part 6b having a smaller circumferential width divided from each other by a stepped portion 6c.

The small part 6b produces two kind of crimping loads. The first crimping load presses the crimping receiving part 5 radially inward of the crimping receiving part 5, and the second crimping load presses the crimping receiving part 5 in its axial direction. When the small part 6b retains the crimping receiving part 5 tightly, the cylinder sleeve 2 and the linier solenoid 3 are attached tightly.

Configuration of a solenoid valve according to the embodiment will be described.

The left side and the right side of FIG. 1A will be hereinafter referred to as a front side and a rear side, respectively, of the solenoid valve in the following discussion. However, it should be noted that the front side and the rear side are used for descriptive purpose only and should not limit a mounting direction of the solenoid valve.

The solenoid valve may be employed as a hydraulic control valve mounted to a hydraulic control unit of an automatic transmission. The solenoid valve has the spool valve 1 and the linier solenoid 3 in which the spool valve 1 and the linier solenoid 3 are coupled with each other in the axial direction by crimping so as to constitute the solenoid valve. The spool valve 1 controls hydraulic, and the linier solenoid 3 actuates the spool valve 1.

The spool valve 1 employs a well-known structure having the cylinder sleeve 2 and a spool. The cylinder sleeve 2 has a generally cylindrical shape and is coupled with the linier solenoid 3 by crimping. The spool is located in the cylinder sleeve 2 and slidably supported in the axial direction, in other words, in the front-rear direction. Specifications can be applied to the spool valve 1, and the spool valve 1 is not limited to a hydraulic control valve.

When a magnetic load is produced by energization of the solenoid valve 3, the linier solenoid 3 actuates the spool to slide in the axial direction against urging force produced by a return spring. The linier solenoid 3 employs a well-known structure having a coil, a plunger, an attractive core, the yoke 4 and a connector 7. The coil produces the magnetic load upon energization. The plunger is slidably supported in the axial direction, in other words, in the front-rear direction. The attractive core magnetically attracts the plunger to the front side by the magnetic load produced by the coil. The yoke 4 has the coil therein, and the connector 7 is for electrical connection between the coil and an external device.

Specifications can be applied to the linier solenoid 3, and the linier solenoid 3 is not limited to this application.

The return spring may be located inside the spool valve 1 of may be located inside the linier solenoid 3.

The yoke 4 has a cylindrical portion made of a magnetic metal, which is a ferromagnetic material such as soft iron, and the cylindrical portion covers the outside of the coil and applies magnetic flux to the coil.

After components of the linier solenoid 3 such as a resin-molded coil and a resin-molded stator are placed inside the yoke 4, the open end of the yoke 4 (an open end of the front side of the yoke 4) is crimped. By having such a structure, the components of the linier solenoid 3 are fixed inside the yoke 4, and the spool valve 1 and the linier solenoid 3 are integrated in a manner that the cylinder sleeve 2 and the yoke 4 are integrated.

Crimping parts of the cylinder sleeve 2 and the yoke 4 will be described in detail below.

An outer periphery of a rear-end portion of the cylinder sleeve 2 has the crimping receiving part 5 that is retained through crimping by the open end of the yoke 4. The crimping receiving part 5 is a ring-shaped projecting part (an annular projecting part) expanding radially outward of the cylinder sleeve 2, and the crimping receiving part 5 is a part of the cylinder sleeve 2.

A front side step (ring-shaped surface) of the crimping receiving part 5 defines a tapered surface 5a retained through crimping by a small part 6b, which will be described below. The tapered surface 5a defines a conical shape whose diameter is decreasing toward the front side and increasing toward the rear side.

On the other hand, the open end of the yoke 4 has the notches A located at regular intervals in a circumferential direction of the yoke 4, and the notches A define the crimping pieces 6. In the embodiment, the open end of the yoke 4 has eight notches A, but the number of the notches A is not limited.

As shown in FIG. 1B, each of the crimping pieces 6 has the large part 6a on a base side (the rear side) of the crimping pieces 6 and the small part 6b on a tip side (the front side) of the crimping pieces 6. A circumferential width of the large part 6a is larger than that of the small part 6b.

According to the embodiment, by having the stepped portion 6c, the large part 6a and the small part 6c are distinguishable. Specifically, part of the crimping piece 6 on the rear side of the stepped portion 6c is configured as the large part 6a, and part of the crimping piece 6 on the front side of the stepped portion 6c is configured as the small part 6b.

The small part 6b bends inward relative to the large part 6a by crimping and presses the tapered surface 5a strongly. In such a manner, the small part 6b produces the two kind of crimping loads. The first crimping load (radially inward load) presses the crimping receiving part 5 in a radially inward direction of the crimping receiving part 5, and the first crimping load (axial load) presses the crimping receiving part 5 in the axial direction (to a bottom side of the yoke, in other words, to the rear side).

A first effect of the embodiment will be described below.

First, according to the embodiment, by having the notches A, the open end of the yoke 4 for crimping has the crimping pieces 6 defined by the notches A. The crimping pieces 6 are deformed plastically easier than an annular crimping part of an entire circumference crimping structure in the conventional technology.

Especially, the small part 6b has low rigidity and is deformed plastically easily and certainly. Therefore, the crimping load can be reduced.

Thus, according to the embodiment, the crimping pieces 6 can be deformed plastically easier than the annular crimping part in the entire circumference crimping structure, especially, because the small part 6b has low rigidity and is deformed plastically easily and certainly.

Therefore, the crimping pieces 6 are restricted from being insufficiently deformed plastically. Then, tight attachment between the yoke 4 and the cylinder sleeve 2 is increased, and the cylinder sleeve 2 has a higher retaining load between the cylinder sleeve 2 and the yoke 4. That is, the solenoid valve can have higher reliability.

Since each of the crimping pieces 6 has the small part 6b, the crimping load is applied concentrically to the small part 6b. Therefore, the small part 6b located on a cylinder sleeve 2 side of the yoke is applied a concentric crimping load through crimping, and the small part 6b and the cylinder sleeve 2 are engaged tightly.

Thus, torque that restricts the cylinder sleeve 2 from rotating relative to the yoke 4 is increased, and the solenoid valve can have higher reliability.

Therefore, according to the solenoid valve of the embodiment, the crimping load can be restricted from increasing, the retaining load between the cylinder sleeve 2 and the yoke 4 can be increased, and torque that restricts the cylinder sleeve 2 from rotating relative to the yoke 4 can be increased.

A second effect of the embodiment will be described below.

According to the embodiment, each of the crimping pieces 6 has the stepped portion 6c between the large part 6a and the small part 6b to define the large part 6a and the small part 6b.

By having the stepped portion 6c, a boundary part between the large part 6a and the small part 6b (the base part of the small part 6b), which defined by the stepped portion 6c, has a significantly low strength. So, the small part 6b bends radially inward easily at the boundary part by crimping. That is, the boundary part is a bending location, and the bending location can be determined as needed by changing locations of the stepped portion 6c.

A third effect of the embodiment will be described below.

The conventional technology employs the entire circumference crimping structure, in which a thickness of the open end of the yoke 4 is reduced by rolling or the like to facilitate plastic deformation of the open end of the yoke 4 through crimping.

By employing a technique to reduce a thickness of the open end of the yoke 4 by rolling or the like, a producing cost of the solenoid valve is increased.

On the other hand, according to the embodiment, only by providing the large part 6a and the small part 6b to be smaller in circumferential widths by punching or the like, rigidity of the crimping pieces 6, especially, rigidity of the small part 6b, is decreased. So, plastic deformation of the crimping pieces 6 can be facilitated.

Thus, a producing cost of the solenoid valve can be smaller than that of a conventional solenoid valve in which a thickness of the open end of the yoke 4 is reduced by rolling or the like.

Industrial applicabilities of the above embodiment will be explained.

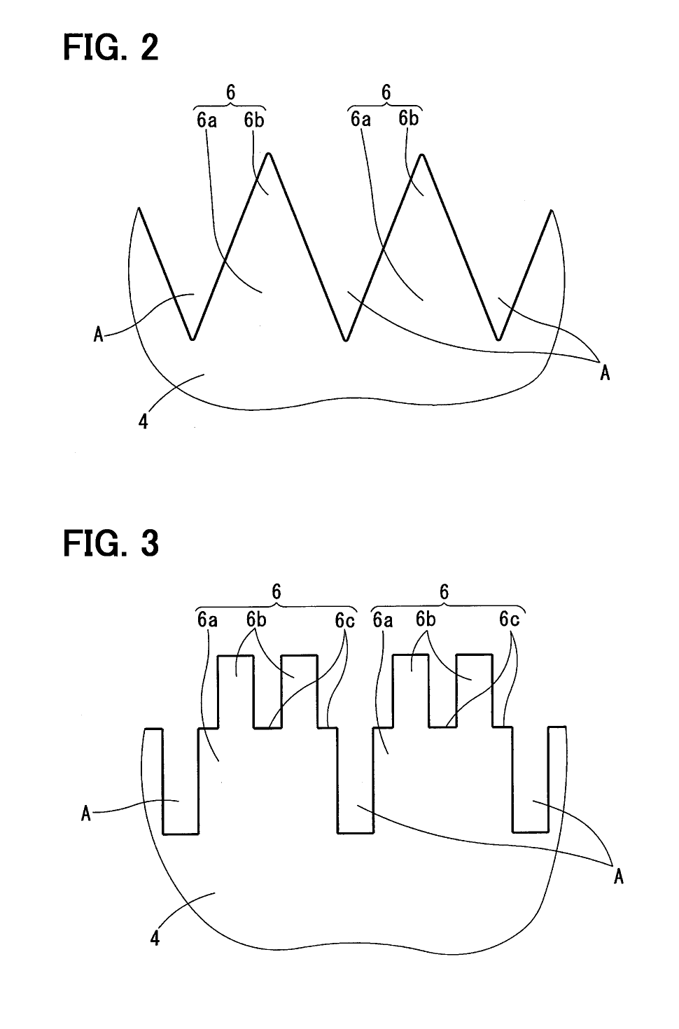

Although each of the crimping pieces 6 has the stepped portion 6c to divide the large part 6a and the small part 6b in the embodiment, each of the crimping pieces 6 may have a triangular shape without the stepped portion 6c as shown in FIG. 2. In such a case, the small part 6b and the large part 6a define a tip portion and a base portion, respectively, of the triangle.

Although the large part 6a has one small part 6b in the embodiment, the large part 6a may have the small parts 6b, for example, two small parts 6b, as shown in FIG. 3.

Although the spool valve 1 is employed as an example of a valve in the embodiment, other valve such as a ball valve or a poppet valve may be applicable.

To sum up, the solenoid valve of the above embodiment can be described as follows.

According to a first aspect of the disclosure, there is provided the solenoid valve in which the open end of the yoke 4 that is crimped to retain the cylinder sleeve 2 has the notches A to define the crimping pieces 6. The crimping pieces 6 are deformed plastically easier than the annular crimping part of the entire circumference crimping structure in the conventional technology. Especially, the small part 6b (the tip portion of the crimping piece 6) has low rigidity, so each of the small parts 6b are deformed plastically easily and certainly.

Thus, the crimping load through crimping is restricted from increasing.

According to a second aspect of the disclosure, there is provided the solenoid valve in which the crimping pieces 6 are deformed plastically easier than the annular crimping part of the entire circumference crimping structure in the conventional technology. Especially, the small parts 6b are deformed plastically easily and certainly because the small parts 6b has low rigidity.

Thus, the crimping pieces 6 are restricted from insufficiently deforming plastically. That is, tight attachment between the yoke 4 and the cylinder sleeve 2 is increased, and the retaining load of the valve housing relative to the yoke 4 is increased.

According to a third aspect of the disclosure, there is provided the solenoid valve in which the small part 6b (the tip portion of the crimping piece 6) is smaller in the circumferential width than the large part 6a (the base portion of the crimping piece 6). So, the crimping load is applied concentrically to the small part 6b. Thus, by applying a concentric crimping load to the small part 6b of the crimping piece 6, the cylinder sleeve 2 side of the crimping piece 6 is deformed, and the small part 6b and the cylinder sleeve 2 are engaged tightly.

Thus, torque that restricts the cylinder sleeve 2 from rotating relative to the yoke 4 is increased.

Such changes and modifications are to be understood as being within the scope of the present disclosure as defined by the appended claims.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A solenoid valve comprising:
a valve that includes a valve housing; and
a linier solenoid that includes a cylindrical yoke and is coupled with the valve, wherein:
an open end of the yoke is crimped to a flanged crimping receiving part provided along an outer periphery of the valve housing, so that the linier solenoid and the valve are coupled together;
the open end of the yoke includes a plurality of notches provided in a circumferential direction of the yoke, and the plurality of notches defines a plurality of crimping pieces; and
each of the plurality of crimping pieces includes:
a large part that is located on a base side of the each of the plurality of crimping pieces and has a larger circumferential width; and
a small part that is located on an tip side of the each of the plurality of crimping pieces and has a smaller circumferential width.

2. The solenoid valve according to claim 1,
wherein each of the plurality of crimping pieces further includes a stepped part at a boundary part between the large part and the small part.

3. The solenoid valve according to claim 1, wherein
the small part is configured to produce both of the following crimping forces:
a crimping force pressing the crimping receiving part radially inward thereof; and
a crimping force pressing the crimping receiving part in an axial direction thereof.

4. The solenoid valve according to claim 1, wherein:
the valve is a spool valve; and
the valve housing is a sleeve of the spool valve.
